(19) United States
(12) Patent Application Publication
(10) Pub. No.: US 2009/0110288 A1
(43) Pub. Date: Apr. 30, 2009

(54) DOCUMENT PROCESSING APPARATUS AND DOCUMENT PROCESSING METHOD

(75) Inventor: Akihiko Fujiwara, Kanagawa-ken (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/260,485

(22) Filed: Oct. 29, 2008

Related U.S. Application Data
(60) Provisional application No. 60/983,431, filed on Oct. 29, 2007.

(30) Foreign Application Priority Data
Aug. 1, 2008 (JP) 2008-199231

(51) Int. Cl. G06K 9/46; G06K 9/62

(52) U.S. Cl. 382/190; 382/224

(57) ABSTRACT

A document processing apparatus comprises a layout analysis module configured to analyze image data input, divide areas for each classification, and acquire coordinate information of a text area from the areas by a classification; a text area information calculation module configured to calculate position information of a partial area for each text area on the basis of the coordinate information acquired by the layout analysis module; a feature extraction module configured to extract features of the text area on the basis of the position information calculated by the text area information calculation module; an analysis executing module configured to analyze semantic information of the partial area using a plurality of kinds of analysis component modules; and a component formation module configured to select and construct one or a plurality of analysis component modules on the basis of the features of the text area extracted by the feature extraction module and permit the analysis executing module to execute analysis of the semantic information of the partial area according to the one or plurality of analysis components modules contracted.

### CROSS-REFERENCE TO RELATED APPLICATION

This application is based upon and claims the benefit of priority from the prior U.S. Patent Application No. 60/983,431, filed on Oct. 29, 2007 and Japanese Patent Application No. 2008-199231, filed on Aug. 1, 2008; the entire contents of all of which are incorporated herein by reference.

### FIELD OF THE INVENTION

The present invention relates to a document processing apparatus and a document processing method for analyzing the area of electronic data of a scanned paper document and analyzing the semantic information of the area in the document.

### DESCRIPTION OF THE BACKGROUND

Conventionally, a paper document is read as an image by a scanner, is filed for each kind of the read document, and is stored in the storage device such as a hard disk. The art of filing the document image is realized by bringing the meaning of each item obtained by analyzing the layout of the image data of the document (hereinafter, referred to as a document image) into correspondence to the text information obtained by the optical character recognition (OCR) and classifying them.

For example, in Japanese Patent Application Publication No. 9-69136, an art of deciding the semantic structure, by using a module, on the judgment basis of the existence of an area in the neighborhood of the area recognized as a character area or the aspect ratio of the area is disclosed. Further, in Japanese Patent Application Publication No. 2001-101213, an art of using the area semantic structure and text information which are analyzed like this for classification of the document is disclosed.

However, a problem arises that these arts are short of the precision of the area semantic analysis and the analytical process takes a lot of time. Further, in Japanese Patent Application Publication No. 9-69136, how to construct and execute each module is not disclosed and a problem arises that a concrete control method can be understood.

Further, a hand scanner OCR inputs and confirms only comparatively small-size characters such as OCR-B font size 1. The observation field of characters in the vertical direction has room of two times or more of the character height in consideration of swinging of the hand, though an isolated character string having a sufficient background white portion around the input information is handled, so that in the transverse direction, only to narrow the width of the portion connected to an object inasmuch as is possible so as to easily see the scanning position is sufficient for practical use.

As described above, a problem arises that the arts of Japanese Patent Application Publication No. 9-69136 and Japanese Patent Application Publication No. 2001-101213 are short of the precision of the area semantic analysis and the analytical process takes a lot of time. Further, how to form each module cannot be understood.

### SUMMARY OF THE INVENTION

The present invention is intended to provide a document processing apparatus and a document processing method, when optimizing selection and formation of an analysis algorithm of extracting semantic information of image data according to the features of the image data, thereby extracting the semantic information, for omitting a useless process and improving the analytical precision.

The document processing apparatus relating to an embodiment of the present invention comprises a layout analysis module configured to analyze image data input, divide areas for each classification, and acquire coordinate information of a text area from the areas by a classification; a text area information calculation module configured to calculate position information of a partial area for each text area on the basis of the coordinate information acquired by the layout analysis module; a feature extraction module configured to extract features of the text area on the basis of the position information calculated by the text area information calculation module; an analysis executing module configured to analyze semantic information of the partial area using a plurality of kinds of analysis component modules; and a component formation module configured to select and construct one or a plurality of analysis component modules on the basis of the features of the text area extracted by the feature extraction module and permit the analysis executing module to execute analysis of the semantic information of the partial area according to the one or plurality of analysis components modules contracted.

The document processing method relating to an embodiment of the present invention comprises analyzing image data input and dividing areas for each classification; acquiring coordinate information of a text area from the areas by the classification; calculating position information of a partial area for each text area on the basis of the coordinate information acquired; extracting features of the text area on the basis of the position information calculated; providing a plurality of kinds of analysis component modules and selecting and constructing one or a plurality of analysis component modules on the basis of the features of the text area extracted; and analyzing semantic information of the partial area according to the one or plurality of analysis components modules contracted.

### BRIEF DESCRIPTION OF THE DRAWINGS

FIG. 1 is a block diagram showing an example of the MFP having the document processing apparatus relating to the embodiments of the present invention;

FIG. 2 is a block diagram showing an example of the constitution of the document processing apparatus relating to the first embodiment of the present invention;

FIG. 3 is a drawing for illustrating the circumscribed rectangle;

FIG. 4 is a flow chart showing the outline of the process of the document processing apparatus relating to the embodiments of the present invention;

FIG. 5 is a drawing showing an example of the semantic information management module relating to the embodiments of the present invention;

FIG. 6 is a flow chart showing an example of the process of the document processing apparatus relating to the first embodiment of the present invention;

FIG. 7 is a drawing showing an example of the effects of the document processing apparatus relating to the first embodiment of the present invention;

FIG. 8 is a block diagram showing an example of the constitution of the document processing apparatus relating to the second embodiment of the present invention;

FIG. 9 is a flow chart showing an example of the process of the document processing apparatus relating to the second embodiment of the present invention;

FIG. 10 is a drawing showing an example of the effects of the document processing apparatus relating to the second embodiment of the present invention;

FIG. 11 is a block diagram showing an example of the constitution of the document processing apparatus relating to the third embodiment of the present invention;

FIG. 12 is a flow chart showing an example of the process of the document processing apparatus relating to the third embodiment of the present invention;

FIG. 13 is a drawing showing an example of the effects of the document processing apparatus relating to the third embodiment of the present invention;

FIG. 14 is a block diagram showing an example of the constitution of the document processing apparatus relating to the fourth embodiment of the present invention;

FIG. 15 is a drawing showing an example of the effects of the document processing apparatus relating to the fourth embodiment of the present invention.

### DETAILED DESCRIPTION OF THE INVENTION

Hereinafter, the embodiments of the present invention will be explained with reference to the accompanying drawings.

The embodiments of the present invention can extract highly precisely area information such as a text, a photograph, a picture, a figure (a graph, a drawing, a chemical formula, etc.), a table (ruled, unruled), a field separator, and a numerical formula from various texts from a business letter of a one-step set to a newspaper of a multiple-step set and multiple-report, can extract a column, a title, a header, a footer, a caption, and a text from the text area, and furthermore can extract a paragraph, a list, a program, a text, a word, a character, and a meaning of the partial area from the text. In addition, the embodiments can structure the semantic information of the extracted area and input and apply it to various application software.

Firstly, the outline of this embodiment will be explained. A printed document can be considered as a form of the knowledge expression. However, for the reason that access to the contents is not simple, or change and correction of the contents cost much, or distribution costs much, or storage requires a physical space and arrangement requires much labor and time, conversion to a digital expression is desired. The reason is that if it is converted to a digital expression form, through various computer applications such as table calculation, image filing, a document management system, a word processor, machine translation, voice reading, groupware, a work flow, and a secretary agent, desired information can be obtained simply in a desired form.

Therefore, a method and an apparatus for reading a printed document using an image scanner or a copying machine, converting it to image data, extracting various information which is a processing object of the aforementioned applications from the image data, and expressing and coding it numerically will be explained below.

Concretely, the method extracts the semantic information from the page-unit image data obtained by scanning the printed document. Here, the “semantic information”, from the text area, means the area information such as “column (step set) structure”, “character line”, “character”, “hierarchical structure (column structure—partial area—line—character)”, “figure (graph, drawing, chemical formula)”, “picture, photograph”, “table, form (ruled, unruled), “field separator”, and “numerical formula” and the information such as “indention”, “centering”, “arrangement”, “hard return (carriage return)”, “document class (document classification such as newspaper, essay, and specification)”, “page attribute (front page, last page, colophon page, page of contents, etc.)”, “logical attribute (title, author's name, abstract, header, footer, page No., etc.), “chapters and verses structure (extending over pages)”, “list (itemizing) structure”, “parent-child link (hierarchical structure of contents)”, “reference link (reference, reference to notes, reference to the non-text area from the text, reference between the non-text area and the caption thereof, reference to the title)”, “hypertext link”, “order (reading order)”, “language”, “topic (title, combination of the headline and the text thereof)”, “paragraph”, “text (unit punctured by a point)”, “word (including a keyword obtained by indexing)”, and “character”.

The extracted semantic information, via various applications, at the point of time when requested from a user, after all objects are dynamically structured and ordered as a whole or partially, is supplied to the user via the application interface. At this time, as a result of the processing, a plurality of possible candidates may be supplied to the application or outputted from the application.

Further, by the GUI (graphical user interface) of the document processing apparatus, similarly, all objects may be dynamically structured or ordered and then displayed.

Furthermore, the structured information, according to the application, may be converted to the form description language format such as the plain text, SGML (standard generalized markup language), or HTML (hyper text markup language) or other word processor formats. The information structured for each page is edited for each document, thus structured information for each document may be generated.

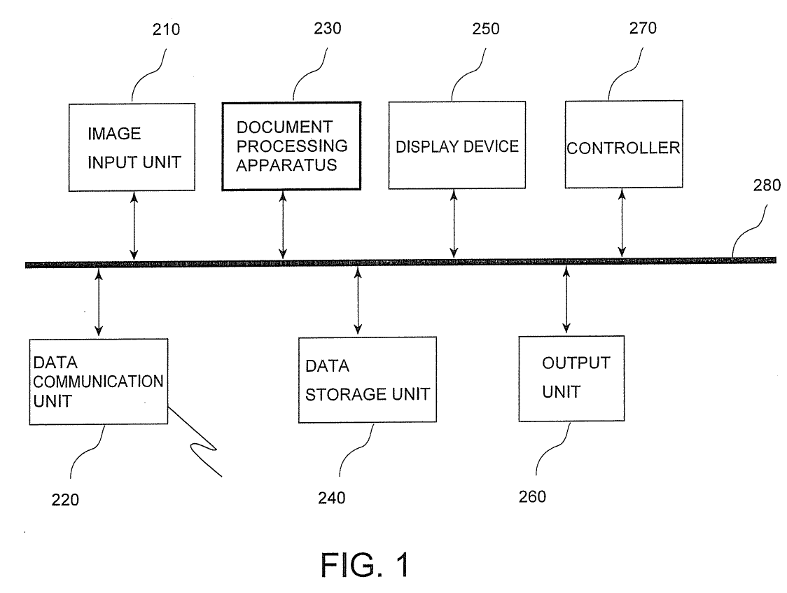

Next, the entire system constitution will be explained. FIG. 1 is a block diagram showing an example of the constitution, for example, of an image forming apparatus (MFP: multi function peripheral) having a document processing apparatus 230 relating to the embodiments of the present invention. In FIG. 1, the image forming apparatus is composed of an image input unit 210 for inputting image data, a data communication unit 220 for executing data communication, a document processing apparatus 230 for extracting the semantic information of the image data, a data storage unit 240 for storing various data, a display device 250 for displaying the processing status and input operation information of the document processing apparatus 230, an output unit 260 for outputting on the basis of the extracted semantic information, and a controller 270.

The image input unit 210 is a unit, for example, for inputting an image obtained by reading a printed document conveyed from an auto document feeder by a scanner. The data storage unit 240 stores the image data from the image input unit 210 and data communication unit 220 and the information extracted by the document processing apparatus 230. The display device 250 is a device for displaying the processing status and input operation of the MFP and is composed of, for example, an LCD (liquid crystal monitor). The output unit 260 outputs a document image as a paper document. The data communication unit 220 is a unit through which the MFP relating to this embodiment and an external terminal transfer data. A data communication path 280 for connecting these units is composed of a communication line such as a LAN (local area network).

The document processing apparatus 230 relating to the embodiments of the present invention extracts the semantic information from the image data and performs the data base process for the extracted semantic information.

### FIRST EMBODIMENT

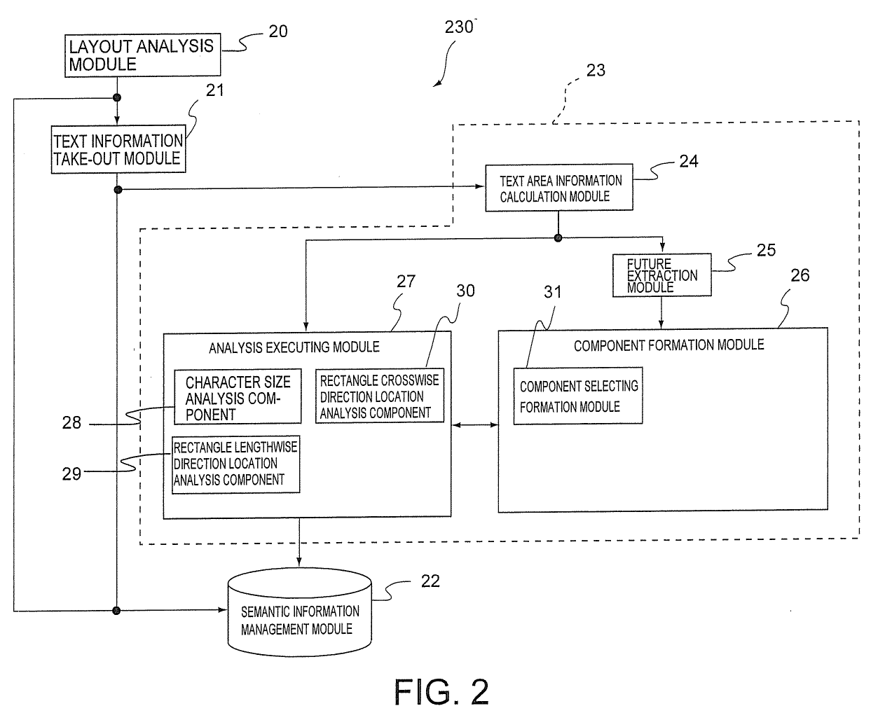

FIG. 2 is a block diagram showing the constitution of the document processing apparatus 230 relating to the first embodiment of the present invention. The document processing apparatus 230 is broadly composed of a layout analysis module 20, a text information take-out module 21, a semantic information management module 22, and a semantic information analysis module 23.

To the layout analysis module 20, the text information take-out module 21, semantic information management module 22, and semantic information analysis module 23 are connected. Namely, the layout analysis module 20 receives a document image which is a binarized document from the image input unit 210, performs the layout analysis process for it, and performs the process of transferring the result to the text information take-out module 21 and semantic information management module 22. The layout analysis process divides the document image into a fixed structure, that is, a text area, a figure area, an image area, and a table area and acquires the information relating to the position of the “partial area” (character line, character string, text paragraph) in the text area as “coordinate information” of the circumscribed rectangle. However, at the point of time of execution of the process by the layout analysis module 20, the meaning of the partial area (the character string means a title) cannot be analyzed.

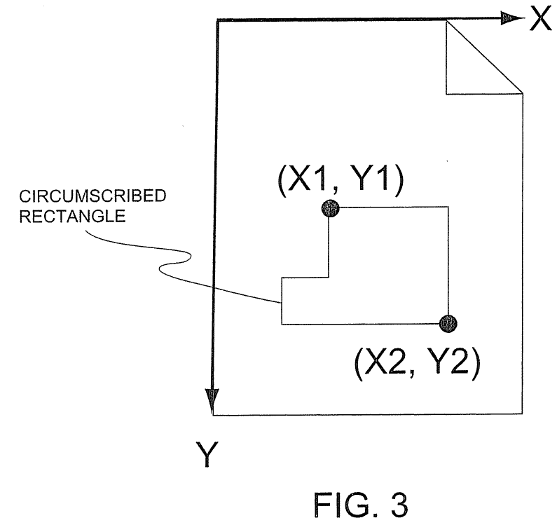

FIG. 3 is a drawing for illustrating the circumscribed rectangle of the document image and “coordinate information”. The circumscribed rectangle is a rectangle circumscribing a character and is information for indicating an area subject to character recognition. The method for obtaining a circumscribed rectangle of each character firstly projects each pixel value of a document image on the Y-axis, searches for a blank portion (a portion free of black characters), discriminates “lines”, and divides the lines. Thereafter, the method projects the document image on the X-axis for each line, searches for a black portion, and divides it for each character. By doing this, each character can be separated by the circumscribed rectangle. Here, the horizontal direction of the document image is assumed as an X-axis, and the perpendicular direction is assumed as a Y-axis, and the position of the circumscribed rectangle is expressed by the XY coordinates.

The area judged as a non-text area (image area, figure area, table area) by the layout analysis module 20 is transferred to the semantic information management module 22. The area judged as a text area is transferred to the text information take-out module 21 and the text information extracted by the text information take-out module 21 is stored in the semantic information management module 22. Simultaneously, the area judged as a text area is transferred to the semantic information analysis module 23.

Here, the text information take-out module 21 is a module for acquiring the text information of the text area in the document image. The “text information” means the character code of the character string in the document image. Concretely, the text information take-out module 21 is a module for analyzing the pixel distribution of the character area extracted by the layout analysis module 20, deciding the character classification by comparing the pixel pattern with the character pixel pattern registered beforehand or the dictionary, and extracting it as text information and concretely, it can be considered to use the OCR.

On the other hand, the semantic information analysis module 23 extracts the semantic information of the text area received from the layout analysis module 20. The semantic information extracted by the semantic information analysis module 23 is stored in the semantic information management module 22.

The semantic information management module 22 stores the area which is not the text area extracted by the layout analysis module 20 including the file device, the text information extracted by the text information take-out module 21, and the semantic information extracted by the semantic information analysis module 23 in the related state.

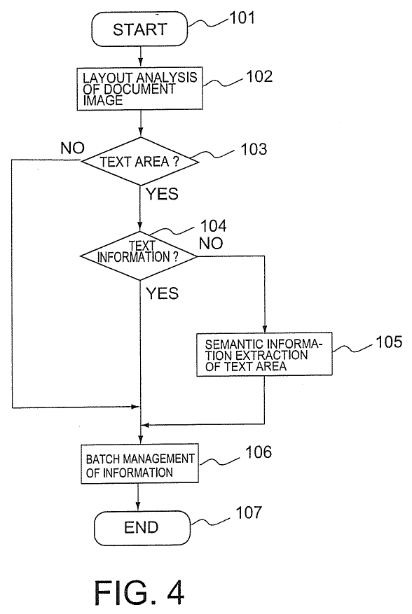

Next, by referring to the flow chart shown in FIG. 4, the entire process of the document processing apparatus 230 will be explained.

The data of the document image from the image input unit 210 is input to the layout area analysis module 20 (Step S101). The layout analysis module 20 analyzes the pixel distribution situation of the document image (Step S102) and divides it into the text area and the others (image area, figure area, table area) (Step S103). And, the information of the image area, figure area, and table area is stored in the semantic information management module 22 (NO at Step S103). Further, with respect to the information of the text area, the text information is extracted by the text information take-out module 21 (YES at Step S104). Furthermore, the semantic information of the text area is extracted by the semantic information analysis module 23 (Step S105). The areas other than the text area, the text information, and the semantic information of the text area are managed and stored in the semantic information management module 22 (Step S106). By the aforementioned process, the process of the document processing apparatus is finished (Step S107).

Here, the semantic information analysis module 23 will be explained in detail by referring to FIG. 2. The semantic information analysis module 23 is composed of the text area information calculation module 24, feature extraction module 25, component formation module 26, and analysis executing module 27.

The text area information calculation module 24, on the basis of the coordinate information of each partial area and text information in the text area extracted by the layout analysis module 20, furthermore acquires the information of the text area. Concretely, on the basis of the coordinate information and text information, the text area information calculation module 24 calculates the height and width of the circumscribed rectangle reaching the partial area in the text area, the interval between the circumscribed rectangle and the circumscribed rectangle, the number of character lines, the direction of the character lines, and the character size.

The feature extraction module 25, on the basis of various information of the text area calculated by the text area information calculation module 24, extracts the “features” of the text area of the document image. Namely, it extracts the features generated highly frequently in the text area using data mining. For example, the method using a histogram disclosed in Japanese Patent Application Publication No. 2004-178010 (for calculating the probability distribution of the mean character size, the probability distribution of the height of each element, the probability distribution of the width of each element, the probability distribution of the number of character lines, the probability distribution of the language classification, and the probability distribution of the character line direction and extracting the features of each probability distribution on the basis of a value below a predetermined threshold value) may be used. Or, a cluster analysis (a method, among the data of the height and width of the circumscribed rectangle reaching the partial area in the text area, the interval between the circumscribed rectangle and the circumscribed rectangle, the number of character lines, and the direction of the character lines, for automatically grouping similar data under the condition that there is no external standard and extracting the features of the core group) may be used. By doing this, for example, in the document image, various features such as “the character size is varied greatly”, “the specific character size is biased”, “the circumscribed rectangle is varied evenly in the direction of the x-axis”, and “the circumscribed rectangle is biased to the center” can be extracted.

The component formation module 26, on the basis of the features extracted by the feature extraction module 25, selects optimum modules to execution of the semantic information analysis from the analysis executing module 27 and combines the selected modules. Thereafter, it permits the analysis executing module 27 to analyze the semantic information. In the analysis executing module 27, there are a plurality of analysis components. The component formation module 26 selects necessary analysis components and combines them, then permits the analysis executing module 27 to execute the analysis components formed in this way.

This embodiment shows an example that a component selecting formation module 31 is installed in the component formation module 26. The component selecting formation module 31 selects the analysis components selected by the component formation module 26 from the analysis executing module 27. And then, the component selecting formation module 31 permits the analysis executing module 27 to execute it.

Here, the analysis executing module 27 is a module for executing extraction of the semantic information and has a plurality of algorithms for enabling the execution. The algorithm for executing extraction of the semantic information is referred to as an “analysis component”. When extracting the semantic information using the analysis component, on the basis of the information acquired by the text area information calculation module 24 such as the height and width of the circumscribed rectangle reaching the partial area in the text area, the interval between the partial areas, the number of character lines, and the direction of the character lines, the analysis executing module 27 actually executes analysis. There are a plurality of kinds of “analysis components”. Concretely, there are a character size analysis component 28, a rectangle lengthwise direction location analysis component 29, and a rectangle crosswise direction location analysis component 30.

The character size analysis component 28 is a module for deciding the semantic information of the partial area from the character size and for example, it is preset to analyze the largest character size as a title and the character paragraph of the smallest character size as a text paragraph. The rectangle lengthwise direction location analysis component 29 is a module for deciding the semantic information of the partial area by the Y-axial value of the document image. The rectangle crosswise direction location analysis component 30 is a module for deciding the semantic information of the partial area by the X-axial value of the document image.

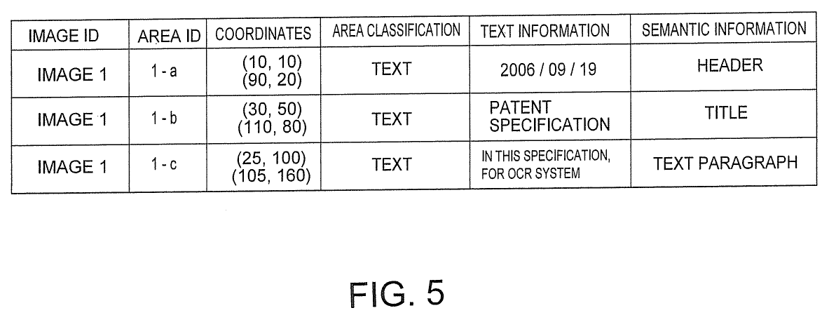

The semantic information is decided by these analysis components and the decided semantic information is stored in the semantic information management module 22. FIG. 5 is a drawing showing the storage table of the semantic information management module 22. Here, the chart area and coordinate information extracted by the layout analysis module 20, the text information acquired by the text information take-out module 21, and the semantic information of the text area analyzed by the analysis executing module 27 are related to each other, managed, and stored.

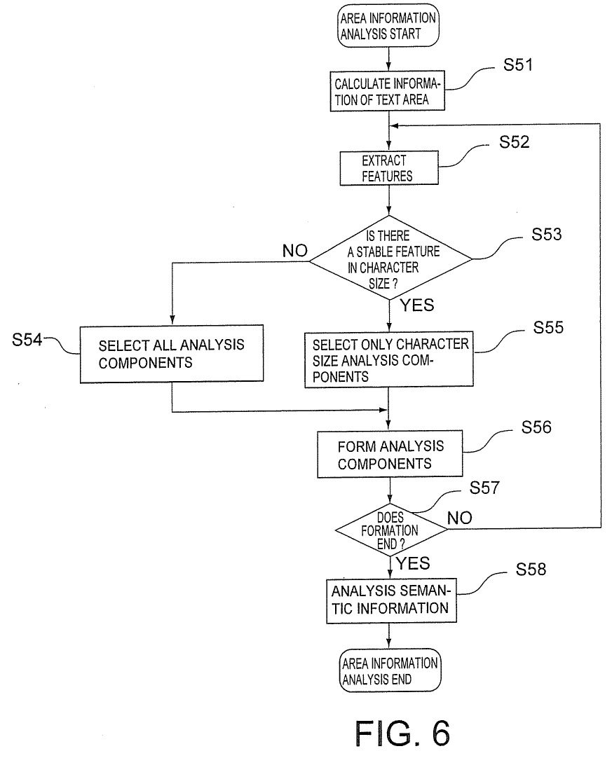

By referring to the flow chart shown in FIG. 6, the operation of the semantic information analysis module 23 will be explained. The semantic information analysis module 23, on the basis of the coordinate information extracted by the layout analysis module 20 and the text information, extracts the semantic information of the text area. Firstly, the text area information calculation module 24, on the basis of the coordinate information of the circumscribed rectangle extracted by the layout analysis module 20, calculates the height and width of the circumscribed rectangle reaching the partial area in the text area, the interval between the partial area and the partial area, the number of character lines, the direction of the character lines, and the size of each character on the character lines (Step S51).

Next, the feature extraction module 25, using the mean value and probability distribution of various information of the text area acquired by the text area information calculation module 24, extracts stable features of the text area of the document image (Step S52).

Next, the component selecting formation module 31 of the component formation module 26, to execute analysis of the semantic information from the stable features, selects an optimum analysis component from the analysis executing module 27. For example, when the character size of the text area is characteristic (YES at Step S53), it selects only the character size analysis component 28 for extracting the semantic information of the area by the character size from the analysis executing module 27 (Step S55). On the other hand, when the character size is not characteristic (NO at Step S53), it selects all the analysis components possessed by the analysis executing module 27. And, the component selecting formation module 31 confirms whether the analysis of the semantic information can be formed by the selected analysis components or not (Step S56). When the formation is not completed, it executes again the execution operation of the features (NO at Step S57). When the formation is completed, the analysis executing module 27, according to the formed component module, for example, the character size analysis component 28, executes analysis of the semantic information (Step S58). As a result, the character size analysis component 28, according to the size of the circumscribed rectangle calculated by the text area information calculation module 24 and the character size, analyzes the character line having the largest character size as a title and the partial area having the smallest size as a text paragraph.

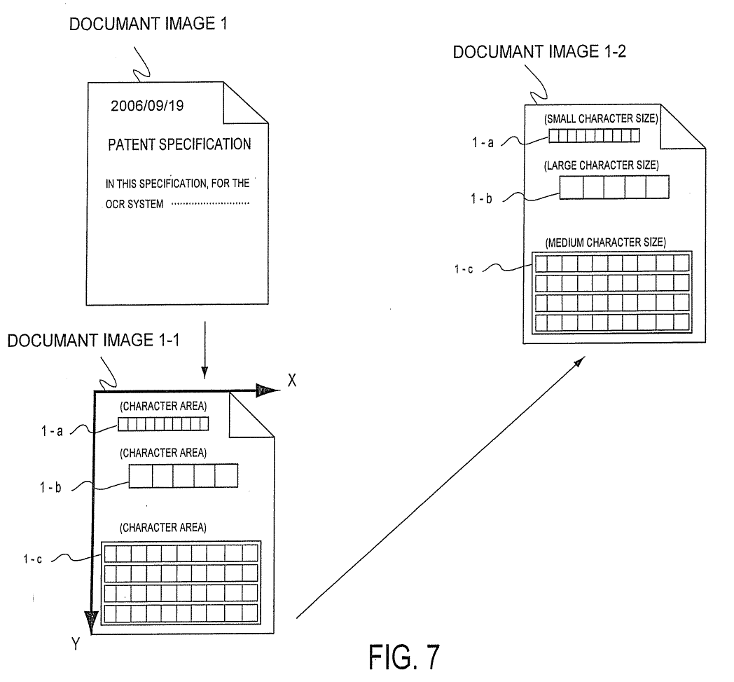

FIG. 7 is a drawing showing the outline of the process performed for the document image 1 scanned by the MFP in time series from the document image 1-1 to 1-2. The document image 1 shown in FIG. 7 has a text area of “2006/09/19”, “Patent Specification”, and “In this specification, regarding the OCR system, . . . ”. Hereinafter, the operation when this embodiment is applied to the document image 1 will be explained.

The layout analysis module 20 divides the text area 1 in the document image and extracts the information of the text area. In this embodiment, as shown in the document image 1-1, the text areas (character areas) of 1-a, 1-b, and 1-c are extracted. Further, the coordinate information of each area is also extracted. For example, assuming the horizontal axis of the document as X-axis and the vertical axis as Y-axis, the coordinates (X1, Y1) of the start point and the coordinates (X2, Y2) of the end point can be obtained as a numerical value and can be analyzed as a value possessed by each text area. Here, it is assumed that the coordinate information relating to the position of the circumscribed rectangle such that an area 1-a includes a start point (10, 8) and an end point (10, 80), and an area 1-b includes a start point (13, 30) and an end point (90, 40), and an area 1-c includes a start point (5, 55) and an end point (130, 155) is obtained. However, at this time, the size of the circumscribed rectangle and the semantic information of the text area cannot be extracted.

Hereafter, by the text area information calculation module 24, on the basis of the coordinate information and text information, the height and width of the circumscribed rectangle reaching the partial area in the text area, the interval between the partial area and the partial area, the number of character lines, and the direction of the character lines are calculated. On the basis of the calculated information, the feature extraction module 25 extracts the features of the document image.

For example, in the document image 1 shown in FIG. 7, it is assumed that the feature that the character size is varied is extracted. Therefore, the component formation module 26 permits the component selecting formation module 31 to select only the character size analysis component 28 (the document image 1-2). And, it permits the analysis executing module 27 to analyze the semantic information of the text area. As a result, the area 1-b having a largest character size can be extracted as a title area. Similarly, the area 1-a can obtain an extraction result of a small character size and the area 1-c can obtain an extraction result of a medium character size.

Finally, the semantic information management module 22 unifies the aforementioned process results. For example, in the document image 1 shown in FIG. 7, the area 1-a manages the header area having the text information of “2006/09/19” as a text paragraph area, and the area 1-b manages the title area having the text information of “Patent Specification” as a text paragraph area, and the area 1-c manages the text information of “In this specification, regarding the OCR system, . . . ” as a text paragraph area. As a result, in the semantic information management module 22, as shown in FIG. 5, in each item of Image ID, Area ID, Coordinates, Area Classification, Text Information, and Area Semantic Information, the extracted information aforementioned is stored.

As mentioned above, according to the document processing system relating to the first embodiment, an appropriate analysis algorithm can be selected and analyzed on the basis of the features of the document image, so that a system for improving the analytical precision and enabling processing in an appropriate processing time can be provided.

Further, an MFP having the document processing apparatus 230 relating to this embodiment extracts a portion automatically necessary (for example, the title portion) and can make the document size smaller, so that the expense for facsimile transmission can be minimized. Further, when transmitting a document by mail with file, when the mail is sent back due to the size restriction of the mail server, the size can be automatically switched to a smaller one.

### SECOND EMBODIMENT

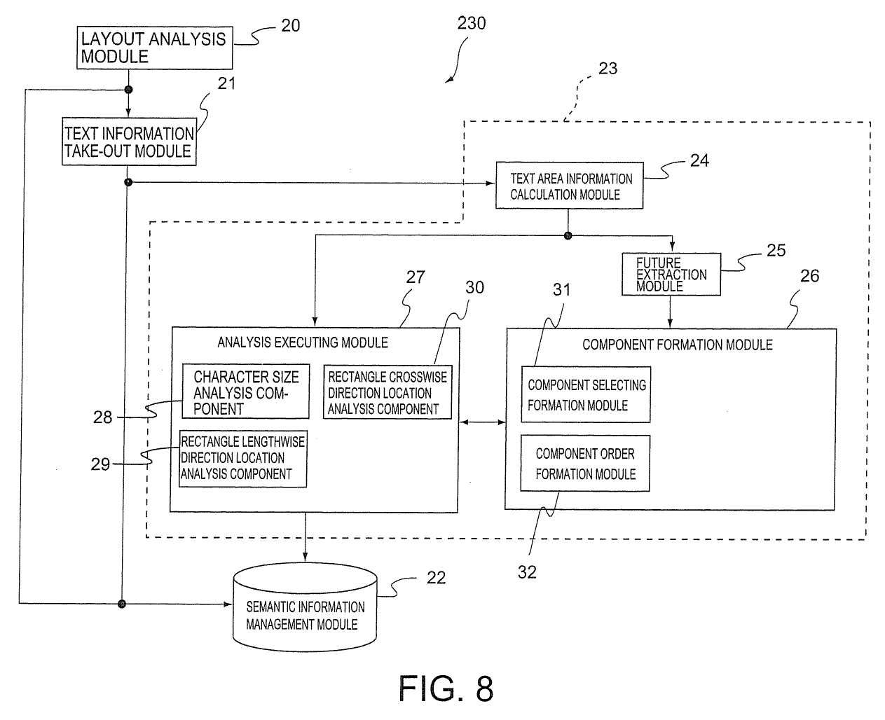

FIG. 8 is a block diagram showing the document processing apparatus 230 relating to the second embodiment. The document processing apparatus 230 of this embodiment, in addition to the system shown in FIG. 2, has a component order formation module 32 installed in the component formation module 26. The component order formation module 32 is a module, when the component formation module 26 selects a plurality of component modules from the analysis executing module 27, for deciding an optimum order of execution of each component module and permitting the analysis executing module 27 to execute analysis of the semantic information.

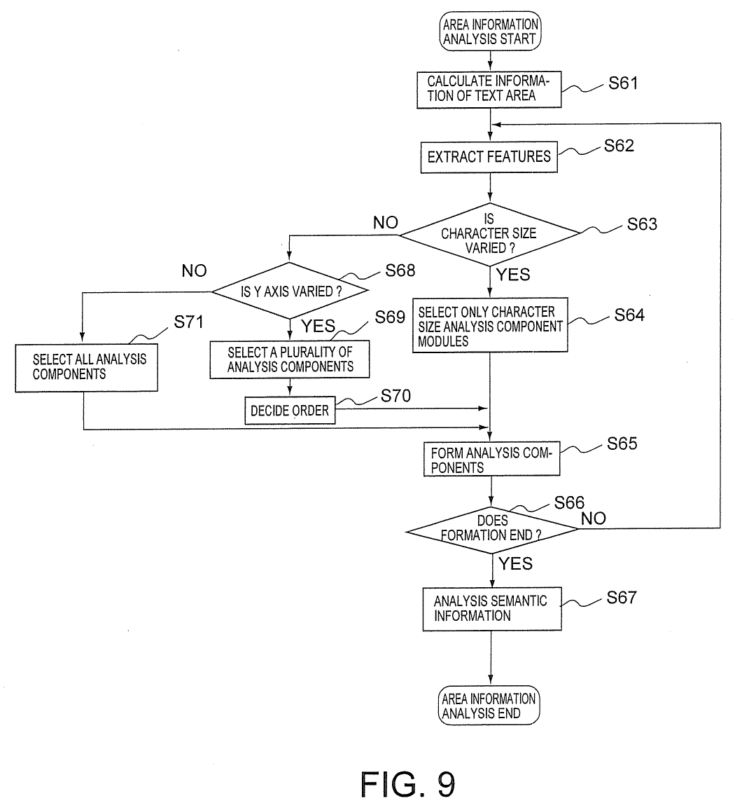

By referring to the flow chart shown in FIG. 9, the analysis of the semantic information in this embodiment will be explained. Firstly, the text area information calculation module 24, on the basis of the coordinate information of the circumscribed rectangle extracted by the layout analysis module 20, calculates the height and width of the circumscribed rectangle reaching the partial area in the text area, the interval between the partial area and the partial area, the number of character lines, the direction of the character lines, and the size of each character on the character lines (Step S61).

Next, the feature extraction module 25, using the height and width of the circumscribed rectangle reaching the partial area in the text area, the interval between the circumscribed rectangle and the circumscribed rectangle, the number of character lines, and various information of the character lines which are calculated by the text area information calculation module 24, extracts the features of the document image (Step S62).

Next, the component selecting formation module 31 of the component formation module 26, to execute analysis of the semantic information from the selected features, selects an optimum analysis component from the analysis executing module 27. For example, when there is a feature that the character size of the text area is varied (YES at Step S63), it selects only the character size analysis component 28 for analyzing the meaning of the area by the character size from the analysis executing module 27 (Step S64) and forms the component module (Step S65). The aforementioned process is the same as that of the first embodiment.

When a feature of “the character size is varied” cannot be extracted (NO at Step S63), the component formation module 26, on the basis of another feature of the document image, selects furthermore an applicable analysis component. Here, for example, when a feature of “the circumscribed rectangle is varied evenly in the Y-axial direction” is extracted (YES at Step S68), the component selecting formation module 31 selects both modules of the character size analysis component 28 and the rectangle lengthwise direction location analysis component 29 (Step S69).

When a plurality of component modules are selected like this, the component order formation module 32 decides the application order of the analysis components (Step S70) and forms the analysis component module (Step S65). Furthermore, when the character size analysis component 28 and rectangle lengthwise direction location analysis component 29 are selected, the candidates of the title and text paragraph are analyzed by the magnitude of the character size by the character size analysis component 28 and are analyzed from the lengthwise position of the partial area in the document image by the rectangle lengthwise direction location analysis component 29, thus from the candidates, the semantic information of the text area can be analyzed.

When the features cannot be extracted at all (NO at Step S68), the component formation module 26 selects all the analysis components (28, 29, 30) (Step S71) and sets so as to form the analysis module (Step S65).

When the analysis modules selected like this are formed (Step S65) and the formation is finished (YES at Step S66), according to these analysis component modules, the analysis executing module 27 executes analysis of the semantic information (Step S67). Further, if the component modules cannot be formed (NO at Step S66), the process is returned to Step S62 and the features of the document image are extracted again.

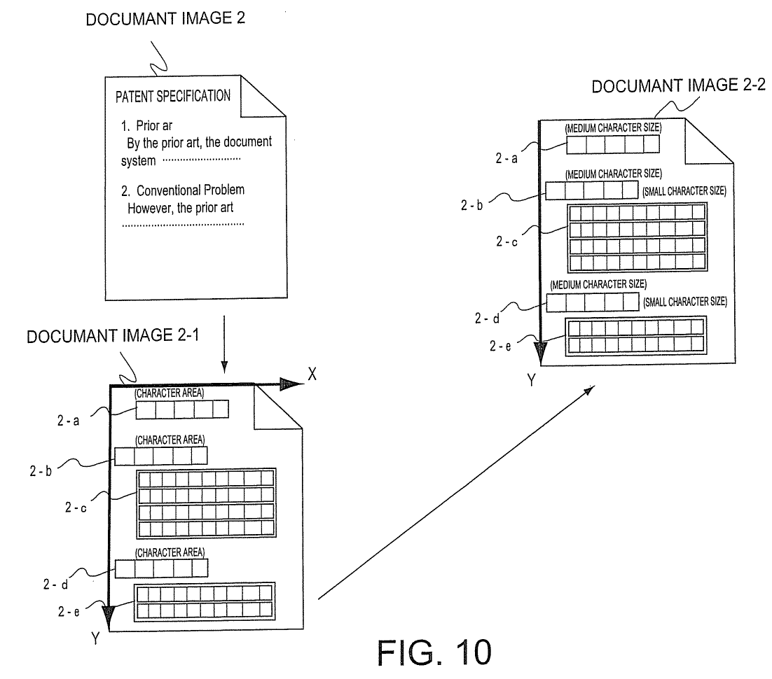

FIG. 10 is a drawing showing the outline of the process performed for the document image 2 scanned by the MFP in time series from the document image 2-1 to 2-2. Here, it is intended to extract the tile in the text area by analyzing the semantic information of the text area.

In the document image 2, on the upper part of the page, a character string of “Patent Specification” of a comparatively large size is arranged, and in the middle of the page, two character strings of “1. Prior Art” and “2. Conventional Problem” of the same size as that of the character string on the upper part of the page are arranged, and in the neighborhood of the two character strings, there are several lines of the character strings of a small character size of “By the prior art, the document system . . . ” and “However, by the prior art, . . . ” displayed. Hereinafter, the operation when this embodiment is applied to the document image 2 will be explained.

Firstly, the text area is extracted by the layout analysis module 20 and the coordinate information is also extracted. For example, as shown in the document image 2-1, the text areas (character areas) of 2-a, 2-b, 2-c, 2-d, and 2-e are extracted and as a value possessed by each text area, an area 2-a is analyzed as a start point (15, 5) and an end point (90, 25), an area 2-b as a start point (5, 30) and an end point (80, 50), an area 2-c as a start point (10, 55) and an end point (130, 100), an area 2-d as a start point (5, 110) and an end point (80, 130), and an area 2-e as a start point (10, 135) and an end point (130, 160).

Hereafter, the text area information calculation module 24, on the basis of the coordinate information and text information, calculates the height and width of the circumscribed rectangle reaching the partial area in the text area, the interval between the partial area and the partial area, the number of character lines, and the direction of the character lines. On the basis of these calculated information, the feature extraction module 25 extracts the features of the document image.

Here, in the document image shown in FIG. 10, the areas 2-a, 2-b, and 2-d are the same in the character size, and the areas 2-c and 2-e are the same in the character size, so that a feature that the variation of the character size itself is small, though there is a character string of a comparatively large character size is extracted. Further, a feature that the trend of the position of the text area is that in the Y-axial direction, a character string of a comparatively large character size and a plurality of character strings of a comparatively small character size are dotted is extracted (the document image 2-1).

Therefore, the component selecting formation module 31 of the component formation module 26, on the basis of the feature that the character size is varied little and the position of the text area is varied in the Y-axial direction, selects the character size analysis component 28 and rectangle lengthwise direction location analysis component 29 and decides an optimum order for applying them. And, as an analysis component for executing the process of selection and combination, the component selecting formation module 31 selects the component order formation module 32.

Here, as a position relationship of the neighboring character areas, the character areas of a comparatively large character size and character areas of a comparatively small character size are individually distributed close to each other, so that it is desirable to sequentially combine and apply the character size analysis component 28 and rectangle lengthwise direction location analysis component 29, thereby analyze the semantic information. Namely, the areas 2-a, 2-b, and 2-d are larger in the character size than the other character areas, so that the character size analysis component 28 selects them as a title candidate and then the rectangle lengthwise direction location analysis component 29 selects, among the areas 2-a, 2-b, and 2-d, a one having the smallest Y-axial value as a title area. As a result of these processes, the area 2-a is selected as a title area and the semantic information can be extracted.

As mentioned above, the second embodiment installs the component order formation module 32 for selecting a plurality of analysis components according to the extracted feature and deciding an optimum order for applying them, thereby can provide the document processing apparatus 230 for improving the analytical precision and enabling processing in an appropriate processing time.

Further, the MFP having the document processing apparatus 230 relating to this embodiment extracts a portion automatically necessary (for example, the title portion) and can make the document size smaller, so that the expense for facsimile transmission can be minimized. Further, when transmitting a document by mail with file, when the mail is sent back due to the size restriction of the mail server, the size can be automatically switched to a smaller one.

### THIRD EMBODIMENT

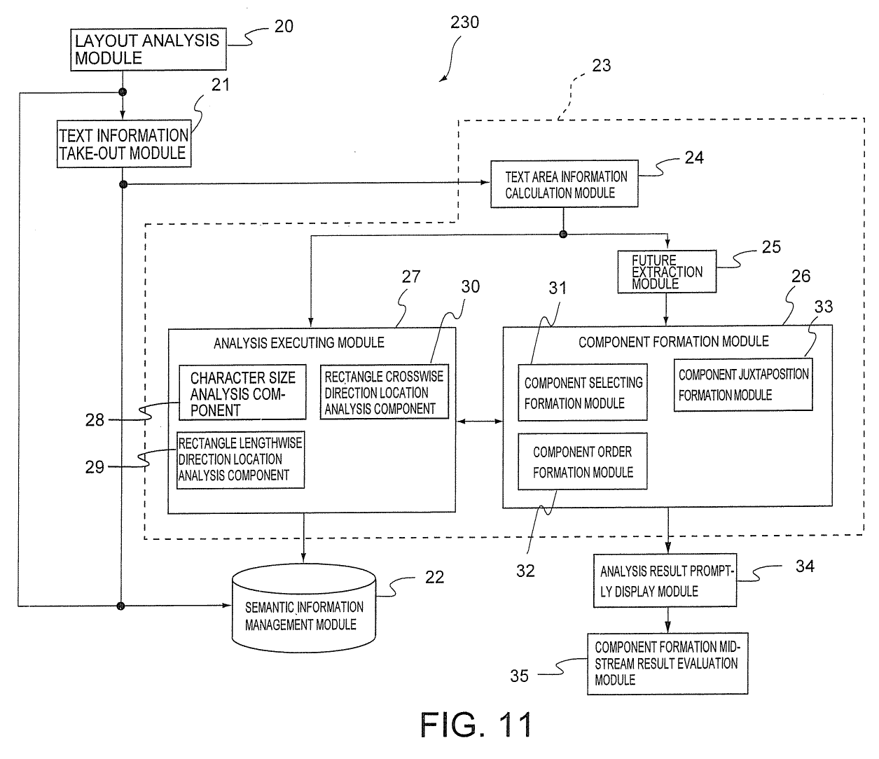

FIG. 11 is a block diagram showing the document processing apparatus relating to the third embodiment of the present invention. In this embodiment, in addition to the second embodiment, a component juxtaposition formation module 33 is installed in the component formation module 26. Furthermore, to the component formation module 26, a component formation midstream result evaluation module 35 is connected via an analysis result promptly displaying module 34.

The component juxtaposition formation module 33 forms a plurality of analysis components selected from the analysis executing module 27 in parallel and applies them to analysis.

The analysis result promptly displaying module 34 is a module for permitting the display device 250 to display each analysis component in the analysis executing module 27 as a visual component, when forming the analysis components by the component formation module 26, permitting the component formation module 26 to display those visual components to a user in a sensuously simple state, and furthermore applying a sample image and the constitution of the aforementioned algorithm component, thereby providing the obtained analysis results to the user.

For example, an icon displayed on the application GUI (graphical user interface) is displayed on the display device 250, and when forming by the component formation module 26, an edit window on which the user can perform an operation of drag and drop on the application GUI is installed on the display device 250, and the user arranges or connects the iron of the analysis component on the window, thereby forms the analysis component, furthermore scans beforehand a paper document having the form to be analyzed, and displays the obtained image information and the results obtained by actually extracting the title from the sample image on the display device 250, thus the operation which is a definition of the analysis component is provided to the user.

The component formation midstream result evaluation module 35 is a module for evaluating whether the midstream result displayed on the analysis result promptly displaying module 34 is affirmative or not. Namely, when a plurality of combinations of a plurality of analysis components selected by the component juxtaposition formation module 33 are set, the component formation midstream result evaluation module 35 is a module for evaluating which is an optimum combination or not.

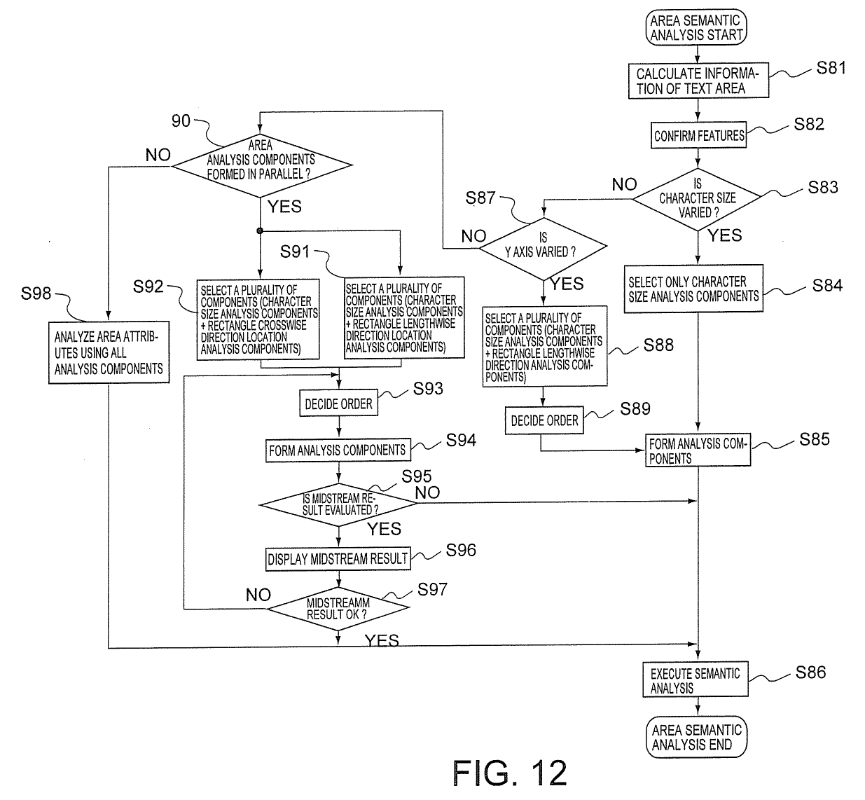

By referring to the flow chart shown in FIG. 12, the analysis process of the semantic information of this embodiment will be explained. Firstly, the text area information calculation module 24, on the basis of the coordinate information of the circumscribed rectangle extracted by the layout analysis module 20, calculates the height and width of the circumscribed rectangle reaching the partial area in the text area, the interval, the number of character lines, the direction of the character lines, and the size of each character on the character lines (Step S81).

Next, the feature extraction module 25, using the height and width of the circumscribed rectangle reaching the partial area in the text area, the interval between the circumscribed rectangle and the circumscribed rectangle, the number of character lines, and various information of the character lines which are calculated by the text area information calculation module 24, extracts the features of the document image (Step S82).

Next, the component selecting formation module 31 of the component formation module 26, to execute analysis of the semantic information from the selected features, selects an optimum analysis component from the analysis executing module 27. For example, when there is a feature of “the character size of the text area is varied” (YES at Step S63), it selects only the character size analysis component 28 for analyzing the meaning of the area by the character size from the analysis executing module 27 (Step S84) and forms the analysis component (Step S85). The aforementioned process is the same as the process of the first and second embodiments.

When a feature of “the character size is varied” cannot be extracted (NO at Step S83), the component formation module 26, on the basis of another feature of the document image, selects furthermore an applicable analysis component. Here, for example, in the document image, when a feature of “the circumscribed rectangle is varied evenly in the Y-axial direction” is extracted (YES at Step S87), the component selecting formation module 31 selects both modules of the character size analysis component 28 and the rectangle lengthwise direction location analysis component 29 (Step S88).

When a plurality of analysis components are selected like this, the component order formation module 32 decides the application order of the analysis components (Step S89) and forms the analysis component (Step S85). For example, when the character size analysis component 28 and rectangle lengthwise direction location analysis component 29 are selected, the candidates of the title and text paragraph are analyzed by the magnitude of the character size by the character size analysis component 28 and are analyzed from the lengthwise position of the partial area in the document image by the rectangle lengthwise direction location analysis component 29, thus from the candidates, the semantic information of the text area can be analyzed.

In this embodiment, when the features cannot be extracted at all at Steps S83 and S87, the component formation module 26 does not select all the analysis components in the analysis executing module 27 (Step S71) and forms the analysis components in parallel or decides them (Step S61). Namely, the component formation module 26 prepares a plurality of combined patterns of the analysis component modules, tests the processes at the same time, and selects an optimum combination.

Here, the patterns are divided into the pattern to be analyzed in the X-axial direction (Step S91) and the pattern to be analyzed in the Y-axial direction (Step S92) for analysis. And, the combination of the analysis components is decided and then the execution order for the analysis components is decided (Step S93). For example, when analyzing on the basis of the X-axial direction, the area meaning is analyzed using the character size analysis component 28 and then the area meaning is extracted using the rectangle crosswise direction location analysis component 30.

Further, when analyzing on the basis of the Y-axial direction, the semantic information is extracted using the character size analysis component 28 and furthermore, the area meaning is extracted using the rectangle lengthwise direction location analysis component 29. The analysis components are formed like this (Step S94), and then it is decided whether or not to evaluate the results of both processes by the component formation midstream result evaluation module 35 (Step S95). When it is decided to evaluate the midstream result (YES at Step S97), the midstream result is displayed (Step S96). When it is decided not to display the midstream result, the analysis of the semantic information is finished (NO at Step S97).

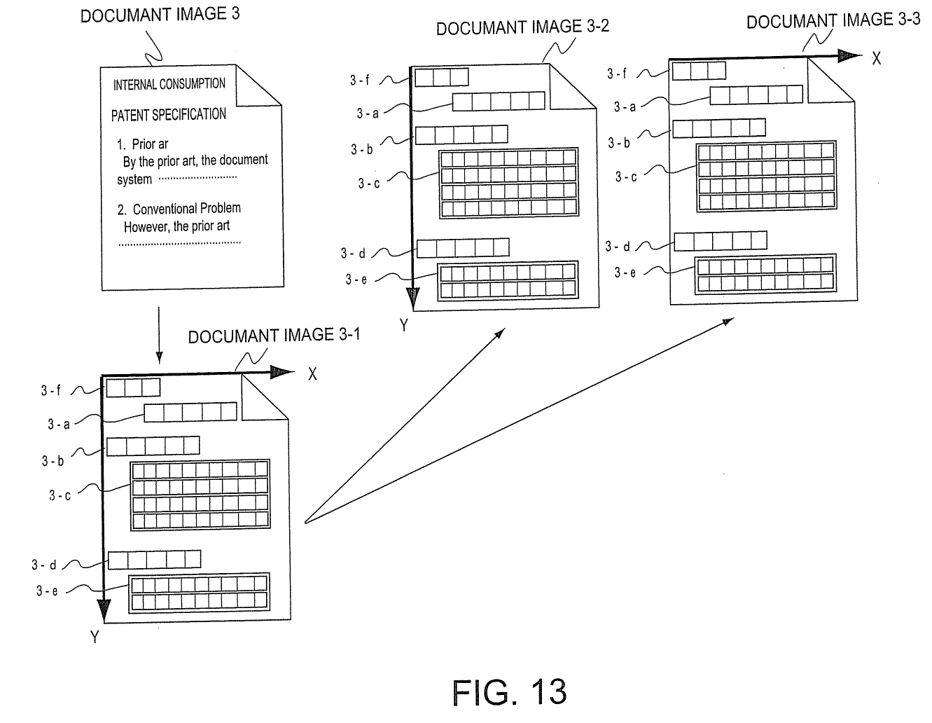

FIG. 13 is a drawing showing the outline of the process performed for the document image 3 scanned by the MFP in time series from the document image 3-1 to 3-3.

The document image 3, as shown in FIG. 13, is an image in which there are two lines of the character strings of a comparatively large character size on the upper part of the page, similarly two lines of the character strings of a comparatively large character size scattered in the page, and several lines of the character strings of a comparatively small character size neighboring with the character strings of a comparatively large character size. Furthermore, with respect to the two lines on the upper part of the page, the line that the starting position thereof is left-justified in the crosswise direction of the page and the line centered at the center are different in the trend. Furthermore, the two lines of the character strings of a comparatively large character size which are scattered in the page are also left-justified.

Firstly, the character area is extracted by the layout analysis module 20 and the parameter information is also extracted. For example, as shown in the document image 3-1, the text areas of 3-f, 3-a, 3-b, 3-c, 3-d, and 3-e are extracted and as a value possessed by each text area, an area 3-f is analyzed as a start point (5, 5) and an end point (35, 25), an area 3-a as a start point (45, 30) and an end point (145, 50), an area 3-b as a start point (5, 50) and an end point (80, 70), an area 3-c as a start point (15, 75) and an end point (125, 110), an area 3-d as a start point (5, 120) and an end point (55, 150), and an area 3-e as a start point (15, 155) and an end point (125, 180).

Hereafter, the text area information calculation module 24, on the basis of the coordinate information and text information, calculates the height and width of the circumscribed rectangle reaching the partial area in the text area, the interval, the number of character lines, and the direction of the character lines. On the basis of these calculated information, the feature extraction module 25 extracts the features of the document image.

Here, the feature extraction module 25 extracts the features that the document image 3 is composed of character strings having small variations in the character size, and there are a plurality of character strings having a comparatively large character size in the page, and the position of the circumscribed rectangle reaching the text area is in the neighborhood of the character string having a comparatively large character size, and there is a character area including a plurality of character strings having a comparatively small character size, and in the character strings having a large character size, there are left-justified lines and centered lines in the cross direction of the page (the document image 3-1).

For the features of the document image 31—obtained like this, the component formation module 26, for this document image, decides the analysis component to be applied when analyzing the area meaning of the area. In the document image 3-1, there are a plurality of character strings of the sane character size, and the position relationship of the neighboring character areas is distributed in the place where the character areas having a comparatively large character size and the character areas having a comparatively small character size are individually close to each, and furthermore, in the start place of the document image of the character strings of the similar character size in the crosswise direction, there are left-justified lines and centered lines, so that the component formation module 26, when analyzing the area meaning, as an analysis component of the analysis executing module 27, selects the character size analysis component 28, the rectangle lengthwise direction location analysis component 29, and the rectangle crosswise direction location analysis component 30.

As mentioned above, when analyzing at the start positions in the page in the lengthwise and crosswise directions, there is a case that the decision results by the analysis components cannot be evaluated in series. For example, firstly, as a result of evaluation in series at the start position in the crosswise direction, due to the decision standard that the lines are right-justified though they are positioned on the upper part of the page, they may be removed from the title candidates. This removed character string, at the start position in the lengthwise direction of the page, has been decided as a very appropriate title candidate and if it is removed from the candidates due to the prior decision in the crosswise direction before giving the decision, there are possibilities that more precise decision results may not be obtained. Therefore, when it is decided to intend to use equivalently a plurality of analysis components like this, it is necessary to form those analysis modules in parallel and apply them to analysis.

As mentioned above, in this embodiment, if the analysis components are formed in parallel, to decide finally the title candidate, it is necessary to compare the analysis results of the analysis components formed in parallel at the halfway stage. Therefore, the component formation midstream result evaluation module 35 displays the midstream results.

In this embodiment, a system that the analysis components are formed in parallel by the component juxtaposition formation module 33, thus the analysis precision is improved, and the process can be performed in an appropriate processing time can be provided. Further, in this embodiment, a plurality of combinations of analysis components are formed in parallel, and the midstream results are displayed, so that a user can evaluate easily the combination of analysis components. By doing this, from the candidates of a plurality of formation results, he can select his desired formation result.

Furthermore, in the MFP having the document processing apparatus 230 relating to this embodiment, a plurality of formation results displayed on the analysis result promptly displaying module 34 can be printed promptly. In addition, the user writes data on a printed sheet of paper with a pen and scans it, thereby can permit the MFP to recognize the user's desired formation result. In this case, it is desirable for the user to input the specific form to be analyzed to the sample image. For example, it is desirable to scan a paper document in which contents such as various information are recorded in the specific form and file and enter the image information in the JPEG form. Further, it is desirable to display the input image information in the “Scan Image Preview” window of the display device 250.

### FOURTH EMBODIMENT

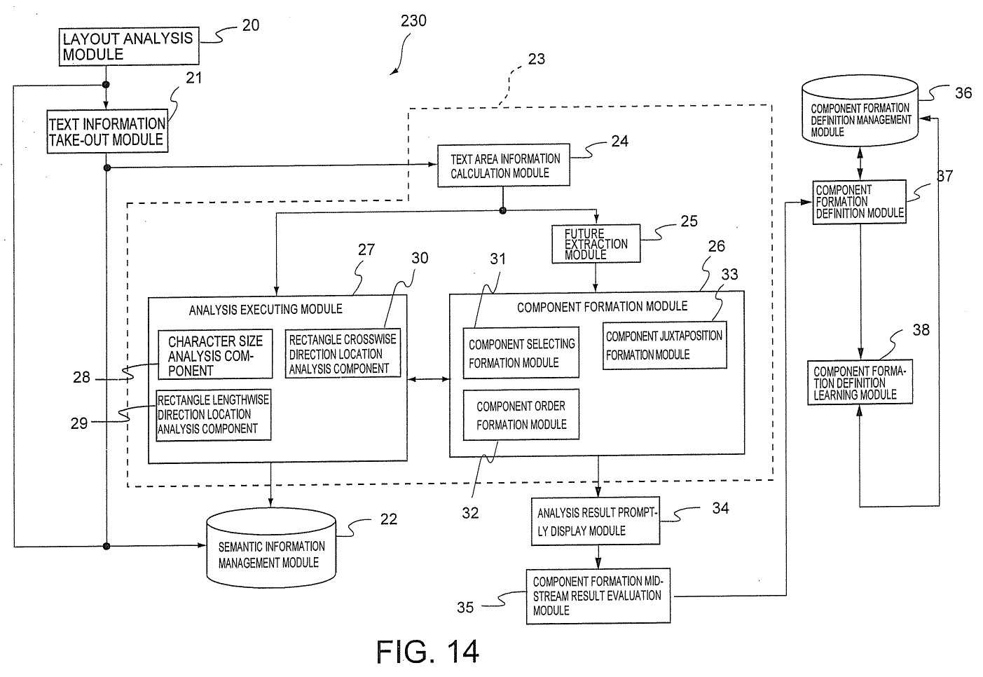

FIG. 14 is a block diagram showing the document processing apparatus 230 relating to the fourth embodiment. The document processing apparatus 230 relating to this embodiment, in addition to the third embodiment, is equipped with a component formation definition management module 36, a component formation definition module 37, and a component formation definition learning module 38.

The component formation definition module 37 is a module for defining the user's desired formation result evaluated by the component formation midstream result evaluation module 35 as an optimum formation result and visually displaying it on the display device 250. Namely, the formation of the analysis components as described in the first to third embodiments is actually executed for the purpose of automatically analyzing the area information such as title extraction for a certain specific form (for example, a document having a specific description item and layout for a specific purpose such as a traveling expense adjustment form or a patent application form). Therefore, the user must define the formation of the analysis components for the specific form and the component formation definition module 37 provides a means for the definition.

The component formation definition learning module 38 is a module for the user to learn the definition of the analysis component formation in the component formation definition module 37. For example, it is a module for relating the features of the text area extracted by the feature extraction module 25 to the combination of analysis components defined by the user and learning a trend that how to recognize and define the semantic information for an image having a certain area trend is executed often by the user.

The component formation definition management module 36 is a module for storing and preserving the formation results of the analysis components defined by the user by the component formation definition module 37 and the information relating to the combination of the analysis components a specific user learned by the component formation definition learning module 38.

The user, so as to obtain a desired analysis result for the image displayed on the display device 250, defines continuously the analysis components. For example, an operation such as arranging the analysis components prepared by the component formation module 26 one by one as an icon and connecting mutually the icons by a line drawing object, thereby expressing the processing flow can be performed. In this case, each icon can be selected by a menu and arranged in the window or an icon list is displayed separately in the window and each icon can be arranged by the operation of drag and drop. Further, not only each analysis component but also a plurality of formation ideas combined by the component juxtaposition formation module 33 can be expressed by arranging icons similar to the indication of the flow chart.

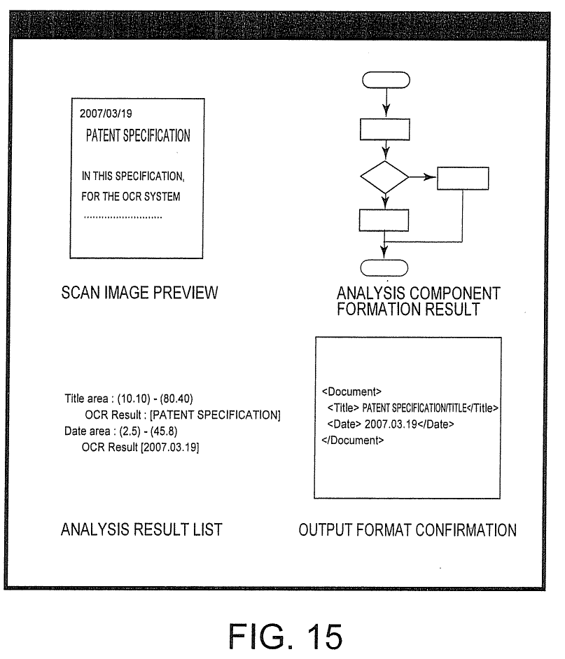

For example, as shown in FIG. 15, it is desirable to display visually the user's desired formation result. If the user defines the formation of the window “Analysis Component Formation Result” shown in FIG. 15, the analysis results are successively displayed in the window “Analysis Result List”. Here, it is assumed that the operation of executing the formation definition for the window “Analysis Component Formation Result” by the user is not performed for a given period of time. Then, the component formation definition module 37 applies the algorithm component formation defined at that time to the sample image displayed on the window “Scan Image Preview” and displays the analysis results in the “Analysis Result List” of the image device 250. In the example shown in FIG. 15, the user is intended to permit the specific form to analyze the title area and data area and displays the analysis results of those areas and the results of execution of the OCR process in the window “Analysis Result List”.

Further, when the user is intended to output the analysis results in a certain format, he can confirm beforehand the output results in the form that the analysis results displayed successively are reflected in the window “Output Format Confirmation”. For example, when the user is intended to output the analysis results in the XML (extensible markup language) format having a certain schema, he presets the schema including a tag and an order for describing the analysis results. Then, in the state that the analysis results obtained according to the formation of the algorithm components defined by the window “Analysis Component Formation Result” are reflected, data is displayed in the window “Output Format Confirmation”, and the user confirms the contents, thereby he can confirm not only the analysis results but also how they are output (here, in the XML format).

As mentioned above, the user can define the algorithm formation for a document in the objective form by the component formation definition module 37, though actually, the operation accompanying the definition is complicated depending on the definition contents, and execution of an operation each time for the similar definition in a different form is applied with a load.

And, in this case, the component formation definition learning module 38 assumes that the user can learn the operation trend of the algorithm formation definition to be executed for a specific form. For example, the objective form features can be acquired by the feature extraction module 25, though the features are parameterized, and the definition executed for the image by the user is also parameterized. To these parameters, for example, cooperative filtering is applied and the trend of the algorithm formation definition collocated for a parameter having a certain image trend can be learned.

The learned results obtained like this are managed as a record of a relational database table by the component formation definition management module 36 together with the defined user's information (for example, keyword information such as the user ID, belonging information, managerial position information, and favorite field, etc.). The information of the algorithm component formation definition managed and stored by the component formation definition management module 36 can be updated by the contents continuously learned by the component formation definition learning module 38 and can be referred to and shared by other users.

As mentioned above, in this embodiment, the algorithm by which the user learns the features of the analysis component formation is stored in the component formation definition management module 36, thus the feature quantity of the area trend analyzed by the feature extraction module 25 and the algorithm component formation pattern defined by the user are related to each other by the component formation definition learning module 38 and the feature of defining the semantic information such that how the user recognizes and defined the semantic information for an image having a certain feature can be learned.

Further, in the MFP having the document processing system of this embodiment, the user can form freely the analysis components, so that regardless of the corporate structure, the MFP can be used.

Furthermore, in this embodiment, the formation results of the analysis components can be stored by the component formation definition management module 36, so that a user making any analysis can visually confirm them.

What is claimed is:

1. A document processing apparatus comprising:
a layout analysis module configured to analyze image data input, divide areas for each classification, and acquire coordinate information of a text area from the areas by a classification;
a text area information calculation module configured to calculate position information of a partial area for each text area on the basis of the coordinate information acquired by the layout analysis module;
a feature extraction module configured to extract features of the text area on the basis of the position information calculated by the text area information calculation module;
an analysis executing module configured to analyze semantic information of the partial area using a plurality of kinds of analysis component modules; and
a component formation module configured to select and construct one or a plurality of analysis component modules on the basis of the features of the text area extracted by the feature extraction module and permit the analysis executing module to execute analysis of the semantic information of the partial area according to the one or plurality of analysis components modules contracted.

2. The apparatus according to claim 1, wherein the image data input is obtained by a scanner to be read from a document.

3. The apparatus according to claim 1 further comprising:
a text information take-out module configured to extract text information in the text area; and
a semantic information management module configured to store and manage an area other than the text area extracted by the layout analysis module, the text information extracted by the text information take-out module, and the semantic information extracted by the analysis executing module by relating them to each other.

4. The apparatus according to claim 1, wherein one of the analysis component modules stored in the analysis executing module is a character size analysis component configured to extract the semantic information of the text area on the basis of a character size.

5. The apparatus according to claim 1, wherein one of the analysis component modules stored in the analysis executing module is a rectangle lengthwise direction location analysis component configured to extract the semantic information of the text area on the basis of a lengthwise direction location of the image data.

6. The apparatus according to claim 1, wherein one of the analysis component modules stored in the analysis executing module is a rectangle crosswise direction location analysis component configured to extract the semantic information of the text area on the basis of a crosswise direction location of the image data.

7. The apparatus according to claim 1, wherein the component formation module has a component selecting formation module configured to select the analysis component module.

8. The apparatus according to claim 7, wherein the component formation module further has a component order formation module, when a plurality of analysis component modules are selected by the component selecting formation module on the basis of the features extracted by the feature extraction module, configured to set an order of the plurality of selected analysis component modules.

9. The apparatus according to claim 7, wherein the component formation module further has a component juxtaposition formation module, when a plurality of combinations of a plurality of analysis component modules are set by the component selecting formation module on the basis of the features extracted by the feature extraction module, configured to permit the analysis executing module to analyze in parallel using an optimum combination of analysis component modules.

10. The apparatus according to claim 9 further comprising:
an analysis result displaying module configured to display analysis results executed in parallel using the component juxtaposition formation module.

11. The apparatus according to claim 10 further comprising:
a component formation result evaluation module configured to evaluate whether the analysis results displayed by the analysis result displaying module are affirmative or not.

12. The apparatus according to claim 11 further comprising:
a component formation definition module configured to define a combination of the analysis component modules having the affirmative evaluation results when the results evaluated by the component formation result evaluation module are affirmative.

13. The apparatus according to claim 11 further comprising:
a component formation learning module configured to store results defined by the component formation definition module; and
a component formation definition management module configured to manage the results defined by the component formation definition module.

14. The apparatus according to claim 13, wherein the component formation definition module updates and defines the analysis results after changing when the results evaluated by the component formation result evaluation module are changed.

15. A document processing method comprising:
analyzing image data input and dividing areas for each classification;
acquiring coordinate information of a text area from the areas by the classification;
calculating position information of a partial area for each text area on the basis of the coordinate information acquired;
extracting features of the text area on the basis of the position information calculated;
providing a plurality of kinds of analysis component modules and selecting and constructing one or a plurality of analysis component modules on the basis of the features of the text area extracted; and
analyzing semantic information of the partial area according to the one or plurality of analysis components modules contracted.

16. The method according to claim 15, wherein the image data input is obtained by a scanner to be read from a document.

17. The method according to claim 15 further comprising:
extracting text information in the text area; and
storing and managing an area other than the text area, the text information extracted, and the semantic information extracted by relating them to each other.

18. The method according to claim 15, wherein one of the analysis component modules is a character size analysis component configured to extract the semantic information of the text area on the basis of a character size.

19. The method according to claim 15, wherein one of the analysis component modules is a rectangle lengthwise direction location analysis component configured to extract the semantic information of the text area on the basis of a lengthwise direction location of the image data.

20. The method according to claim 15, wherein one of the analysis component modules is a rectangle crosswise direction location analysis component configured to extract the semantic information of the text area on the basis of a crosswise direction location of the image data.
